(19) United States
(12) Patent Application Publication
(10) Pub. No.: US 2024/0064736 A1
(43) Pub. Date: Feb. 22, 2024

(54) METHOD AND APPARATUS FOR RESOURCE CONFIGURATION FOR CONFIGURED GRANT BASED TRANSMISSION

(71) Applicant: Telefonaktiebolaget LM Ericsson (publ), Stockholm (SE)

(72) Inventors: Zhipeng LIN, NANJING Jiangsu (CN); Jingya LI, GÖTEBORG (SE)

(73) Assignee: Telefonaktiebolaget LM Ericsson (publ), Stockholm (SE)

(21) Appl. No.: 18/270,449

(22) PCT Filed: Dec. 20, 2021
(86) PCT No.: PCT/CN2021/139732

§ 371 Date: Jun. 29, 2023

(30) Foreign Application Priority Data
Dec. 31, 2020 (WO) PCT/CN2020/142372
Jan. 14, 2021 (WO) PCT/CN2021/071787

(51) Int. Cl. H04W 72/1268

(52) U.S. Cl. CPC H04W 72/1268

(57) ABSTRACT

Embodiments of the present disclosure provide methods, apparatus, and computer program products for configured grant (CG)-based transmission in non-RRC connected state. A method comprises determining resource configuration indicative of one or more physical uplink shared channel (PUSCH) resources allocated for the CG based transmission; and transmitting to a network node, data of the CG based transmission from a user equipment in the non-RRC connected state by utilizing the one or more PUSCH resources according to the determined resource configuration.

### TECHNICAL FIELD

The non-limiting and exemplary embodiments of the present disclosure generally relate to the technical field of wireless communications, and specifically to methods, apparatuses and computer programs for resource configuration for configured grant (CG) based transmission.

### BACKGROUND

This section introduces aspects that may facilitate a better understanding of the disclosure. Accordingly, the statements of this section are to be read in this light and are not to be understood as admissions about what is in the prior art or what is not in the prior art.

The 5^{th} generation (5G) communication needs to support services that typically requires only infrequent small data traffic. Examples of these services include traffic from instant messaging (IM) services, such as WhatsApp and WeChat, heart-beat traffic from IM/email clients and other apps, push notifications from various applications, industrial wireless sensors transmitting temperature, or pressure data periodically, etc.

The new radio (NR) supports RRC_INACTIVE state. User Equipments (UEs) with infrequent (periodic and/or non-periodic) data transmission are generally maintained by the network in the RRC_CONNECTED state. Until NR Rel-16, the RRC_INACTIVE state doesn't support data transmission. Hence, the UE has to resume the connection (i.e. move to RRC_CONNECTED state) for any downlink and uplink data. Connection setup and subsequently release to INACTIVE state happens for each data transmission regardless of how small and infrequent the data packets are. This results in unnecessary power consumption and signaling overhead. The signaling overhead for setting up connections before each transmission can be larger than the size of the actual data payload. To reduce the signaling overhead and improve UE battery life, a research on small data transmission (SDT) in RRC_INACTIVE state is ongoing.

Two main solutions are proposed for enabling SDT in RRC_INACTIVE state: RACH-based SDT, which transmits data of SDT on Message A PUSCH (Physical Uplink Shared Channel) in a 2-step RACH (Random Access Channel) procedure, or transmits data of SDT on Message 3 PUSCH in a 4-step RACH procedure; and configured grant (CG) based SDT, which transmits data of SDT over configured grant type-1 PUSCH resources. The 2-step RACH procedure, 4-step RACH procedure and configured grant type-1 PUSCH transmission have already been specified as part of NR Rel-15 and Rel-16. So, these two solutions enable small data transmission in INACTIVE state for NR.

For RACH-based SDT, a UE can detect one good SSB (synchronization signal and physical broadcast channel blocks) beam. A random-access preamble in the set of one or more preambles mapped to this good SSB beam can be selected for the random access. Thus, when a gNB detects the selected preamble, the good SSB beam for this UE is known indirectly at the gNB, so that a beam alignment between a UE and a gNB can be achieved. For example, best beams can be used for transmitting signals to or receiving signals from this UE.

For CG-based SDT, the RACH procedure is skipped. After selecting an SSB, a UE will transmit its small data on CG PUSCH resource(s), that is pre-configured for its SDT. A gNB cannot know which SSB beam is good for this UE. Therefore, an association between CG PUSCH resource(s) and SSB(s) is required for CG-based SDT to achieve the beam alignment between the UE and the gNB.

To support CG based transmission (e.g. CG-based SDT) in RRC inactive state, especially a mapping of SSB(s) to CG PUSCH resource(s), it is necessary to define configuration of CG PUSCH resources used for CG-based SDT in RRC inactive state.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Various embodiments of the present disclosure mainly aim at providing methods, apparatuses and computer programs for resource configuration for CG based transmission in RRC inactive state. Other features and advantages of embodiments of the present disclosure will also be understood from the following description of specific embodiments when read in conjunction with the accompanying drawings, which illustrate, by way of example, the principles of embodiments of the present disclosure.

In a first aspect of the present disclosure, there is provided a method for configured grant (CG) based transmission in a non-radio resource control (RRC) connected state. The method comprises: determining resource configuration indicative of one or more physical uplink shared channel (PUSCH) resources allocated for the CG based transmission; and transmitting to a network node, data of the CG based transmission from a user equipment in the non-RRC connected state by utilizing the one or more PUSCH resources according to the determined resource configuration.

In some embodiments, the method may further comprise: receiving from the network node, an RRC signaling indicative of the resource configuration.

In some embodiments, the resource configuration may be determined from an allocation list of time domain resources for the CG based transmission in the non-RRC connected state.

In some embodiments, the method may further comprise: receiving the allocation list in an RRC signaling from the network node. The allocation list may be indicated by at least one of the following parameters in the RRC signaling: a higher layer parameter indicative of information on configured uplink grant, a higher layer parameter indicative of information on CG configuration, and a higher layer parameter indicative of information on PUSCH configuration.

In some embodiments, the resource configuration may be determined from a default allocation list of time domain resources which is predetermined for the CG based transmission in the non-RRC connected state. The default allocation list of time domain resources may be a default time domain resource allocation table.

In some embodiments, the allocation list may be a reuse of at least one allocation list of time domain resources of PUSCH configured for transmission in an RRC connected state.

In some embodiments, the method may further comprise: selecting an allocation list of time domain resources from multiple allocation lists of time domain resources, as the allocation list of time domain resources for the CG based transmission in the non-RRC connected state. The selecting may be performed according to the following priority from high to low: an allocation list of time domain resources received in an RRC signaling, an allocation list of time domain resources received in a system message, and a default allocation list of time domain resources.

In some embodiments, the method may further comprise receiving from the network node an RRC signaling which comprises at least one of the following parameters: a starting symbol relative to a start of a slot, a number of symbols allocated for the CG based transmission in a slot, a PUSCH mapping type, and a number of PUSCH repetitions.

In some embodiments, according to the determined resource configuration, multiple PUSCH occasions in a CG period may be configured for the CG based transmission in the non-RRC connected state.

In some embodiments, the multiple PUSCH occasions may comprise multiple PUSCH occasions in a time domain per CG period. In some embodiments, the multiple PUSCH occasions in the time domain per CG period may be configured with at least one of the following parameters: a number of slots containing the one or multiple PUSCH occasions, and a number of PUSCH occasions configured to the CG based transmission in a slot. In some embodiments, the multiple PUSCH occasions in the time domain per CG period may be configured with a parameter indicating a total number of the multiple PUSCH occasions in the time domain per CG period.

In some embodiments, the multiple PUSCH occasions in the time domain per CG period may be configured based on a PUSCH repetition type for the CG based transmission.

In some embodiments, a starting symbol and a length of a first PUSCH occasion of the multiple PUSCH occasions in the time domain per CG period may be determined by a high layer parameter indicative of information on allocation of time domain resources and/or an allocation list of time domain resources. The method may further comprise: receiving from the network node, an RRC signaling which comprises a starting symbol and a length of a first PUSCH occasion of the multiple PUSCH occasions in the time domain per CG period.

In some embodiments, a total number of the multiple PUSCH occasions in the time domain per CG period may be configured to be divisible by a number of supported PUSCH repetitions.

In some embodiments, the multiple PUSCH occasions may comprise multiple PUSCH occasions in a frequency domain per CG period. The multiple PUSCH occasions in the frequency domain per CG period may be configured with a parameter indicating a total number of the multiple PUSCH occasions in the frequency domain per CG period. In some embodiments, the multiple PUSCH occasions in the frequency domain per CG period may be configured with a gap between different PUSCH occasions multiplexed in the frequency domain.

In some embodiments, when frequency hopping is enabled, a same frequency offset between hops is used for frequency hopping for different PUSCH occasions multiplexed in the frequency domain.

In some embodiments, the one or more PUSCH resources may be allocated in a predetermined bandwidth part. In some embodiments, the method may further comprise: receiving from the network node, an RRC signaling indicative of a bandwidth part configured for the one or more PUSCH resources.

In some embodiments, both PUSCH repetition type A and PUSCH repetition type B may be supported for the CG based transmission on the one or more PUSCH resources. In some other embodiments, only PUSCH repetition type A may be supported for the CG based transmission on the one or more PUSCH resources.

In some embodiments, different one or multiple PUSCH repetitions may be mapped to different one or multiple synchronization signal and physical broadcast channel blocks (SSBs). The method may further comprise: determining one or more SSBs; determining one or more PUSCH repetitions mapped to the determined one or more SSBs; and transmitting the data of the CG based transmission by utilizing the one or more PUSCH resources of the determined one or more PUSCH repetition.

In some embodiments, the resource configuration may comprise one or more synchronization signal and physical broadcast channel block (SSB) indexes to be used for association with the CG based transmission in the non-RRC connected state. The one or more SSB indexes may be indicated by a parameter in an RRC signaling.

In an embodiment, the method may further comprise receiving from the network node, an RRC signaling which comprises a parameter indicating the one or more SSB indexes; and determining one or more SSBs associated to the one or more PUSCH resources according to the parameter indicating the one or more SSB indexes.

In another embodiment, the method may further comprise determining one or more SSBs associated to the one or more PUSCH resources according to the parameter indicating the one or more SSB indexes, if an RRC signaling which comprises a parameter indicating the one or more SSB indexes is received; and otherwise, determining one or more SSBs associated to the one or more PUSCH resources according to mappings between a set of SSBs and a set of PUSCH resources.

In some embodiments, the method may further comprise: determining an extended CG period of the CG based transmission, wherein the extended CG period is determined by a time offset added to a normal CG period, or by a newly defined CG period value compared to supported CG periods.

In some embodiments, the RRC signaling may be an RRC release message.

In some embodiments, the non-RRC connected state may be an RRC inactive state or an RRC idle state.

In some embodiments, the CG based transmission may be a CG-based small data transmission.

In a second aspect of the present disclosure, there is provided a method for CG based transmission in a non-radio resource control (RRC) connected state. The method comprises: determining resource configuration indicative of one or more physical uplink shared channel (PUSCH) resources allocated for the CG based transmission; and receiving at a network node, data of the CG based transmission from a user equipment in the non-RRC connected state by utilizing the one or more PUSCH resources according to the determined resource configuration.

In some embodiments, the method may further comprise: transmitting to the user equipment, an RRC signaling indicative of the resource configuration.

The resource configuration may be defined in a same way as described with respect to the first aspect.

In some embodiments, the method may further comprise: receiving the allocation list in an RRC signaling from the network node. The allocation list may be indicated by at least one of the following parameters in the RRC signaling: a higher layer parameter indicative of information on configured uplink grant, a higher layer parameter indicative of information on CG configuration, and a higher layer parameter indicative of information on PUSCH configuration.

In some embodiments, the method may further comprise: selecting an allocation list of time domain resources from multiple allocation lists of time domain resources, as the allocation list of time domain resources for the CG based transmission in the non-RRC connected state. The selecting may be performed according to the following priority from high to low: an allocation list of time domain resources transmitted to the user equipment in an RRC signaling, an allocation list of time domain resources transmitted to the user equipment in a system message, and a default allocation list of time domain resources.

In some embodiments, the method may further comprise: transmitting from the network node to the user equipment, an RRC signaling which comprises at least one of the following parameters: a starting symbol relative to a start of a slot, a number of symbols allocated for the CG based transmission in a slot, a PUSCH mapping type, and a number of PUSCH repetitions.

In some embodiments, the method may further comprise: transmitting from the network node to the user equipment, an RRC signaling which comprises a starting symbol and a length of a first PUSCH occasion of the multiple PUSCH occasions in the time domain per CG period.

In some embodiments, the method may further comprise: transmitting from the network node to the user equipment, an RRC signaling indicative of a bandwidth part configured for the one or more PUSCH resources.

In some embodiments, different one or multiple PUSCH repetitions may be mapped to different one or multiple synchronization signal and physical broadcast channel blocks (SSBs). The method may further comprise: determining one or more PUSCH repetition in which the one or more PUSCH resources is allocated, determining one or more SSBs mapped to the determined one or more PUSCH repetitions; and transmitting data to the user equipment by utilizing the determined one or more SSBs.

In some embodiments, the method may further comprise: determining an extended CG period of the CG based transmission, wherein the extended CG period is determined by a time offset added to a normal CG period, or by a newly defined CG period value compared to supported CG periods.

In some embodiments, the method may further comprise: transmitting to the user equipment, an RRC signaling which comprises a parameter indicating the one or more SSB indexes to be used for association with the CG based transmission in the non-RRC connected state.

In a third aspect of the present disclosure, there is provided an apparatus. The apparatus may comprise a processor and a memory coupled to the processor. The memory may contain instructions executable by the processor, whereby the apparatus is operative to perform any step of the method according to the first aspect of the disclosure

In a fourth aspect of the present disclosure, there is provided an apparatus. The apparatus may comprise a processor and a memory coupled to the processor. The memory may contain instructions executable by the processor, whereby the apparatus is operative to perform any step of the method according to the second aspect of the disclosure.

In a fifth aspect of the present disclosure, there is provided a computer-readable medium having computer program codes embodied thereon which, when executed on a computer, cause the computer to perform any step of the method according to the first aspect of the present disclosure.

Ina sixth aspect of the present disclosure, there is provided a computer-readable medium having computer program codes embodied thereon which, when executed on a computer, cause the computer to perform any step of the method according to the second aspect of the present disclosure.

According to the various aspects and embodiments as mentioned above, it can enhance efficiency for CG based transmission.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 illustrates an example of SSB multi-beam sweeping;

FIG. 2 illustrates an example of PUSCH resources pre-configured by using Configured Grant Type 1 scheme;

FIG. 3 illustrate a flowchart of a method for CG based transmission at a user equipment according to some embodiments of the present disclosure;

FIG. 4 illustrates a flowchart of a method for CG based transmission at a network node according to some embodiments of the present disclosure;

FIG. 5 illustrates an example of configuration of multiple PUSCH occasions in a time domain within each CG period, according to some embodiments of the present disclosure;

FIG. 6 illustrates an example of configuration of multiple PUSCH occasions in a frequency domain within each CG period, according to some embodiments of the present disclosure;

FIG. 7 illustrate an example of configuration of multiple PUSCH occasions in a time domain and frequency domain within each CG period, according to some embodiments of the present disclosure;

FIG. 8 is a block diagram illustrating an apparatus according to some embodiments of the present disclosure;

FIG. 9 are block diagrams illustrating apparatus according to some embodiments of the present disclosure;

FIG. 10 are block diagram illustrating apparatus according to some embodiments of the present disclosure;

FIG. 11 is a block diagram illustrating a telecommunication network connected via an intermediate network to a host computer, according to some embodiments of the present disclosure;

FIG. 12 is a block diagram illustrating a host computer communicating via a base station with a UE over a partially wireless connection, according to some embodiments of the present disclosure;

FIG. 13 is a flowchart illustrating a method implemented in a communication system, according to an embodiment of the present disclosure;

FIG. 14 is a flowchart illustrating a method implemented in a communication system, according to an embodiment of the present disclosure;

FIG. 15 is a flowchart illustrating a method implemented in a communication system, according to an embodiment of the present disclosure; and

FIG. 16 is a flowchart illustrating a method implemented in a communication system, according to an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “user equipment” refers to any end device that can access a communication network and receive services therefrom. By way of example and not limitation, the user equipment may refer to a UE, a terminal device or other suitable devices. The UE may be, for example, a subscriber station, a portable subscriber station, a mobile station (MS) or an access terminal (AT). The user equipment may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a user equipment may also be called an IoT device and represent a machine or other device that performs monitoring, sensing and/or measurements etc., and transmits the results of such monitoring, sensing and/or measurements etc. to another terminal device and/or a network equipment. The user equipment may in this case be a machine-to-machine (M2M) device, which may in a 3rd generation partnership project (3GPP) context be referred to as a machine-type communication (MTC) device.

As one particular example, the user equipment may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a user equipment may represent a vehicle or other equipment, for example, a medical instrument that is capable of monitoring, sensing and/or reporting etc. on its operational status or other functions associated with its operation.

As used herein, the singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

In the following description and claims, unless defined otherwise, all technical and scientific terms used herein have the same meaning as commonly understood by one of ordinary skills in the art to which this disclosure belongs. For example, the term “user equipment” used herein may refer to any terminal device or user equipment (UE) having wireless communication capabilities, including but not limited to, mobile phones, cellular phones, smart phones, or personal digital assistants (PDAs), portable computers, image capture devices such as digital cameras, gaming devices, music storage and playback appliances, wearable devices, vehicle-mounted wireless device and the like. In the following description, the terms “terminal device”, “user equipment” and “UE” may be used interchangeably. Similarly, the term “network node” may represent any network functionality in a 5G network.

This disclosure focuses on schemes for the CG based transmission, such as CG based small data transmission (SDT). A configuration of CG resource to be used for small data transmission of a UE in uplink can be contained in the RRC Release message. The configuration may be only type 1 CG with no contention resolution procedure for CG. A configuration of CG resources may include one type 1 CG configuration. The configuration of CG resources for small data transmission of a UE is valid only in a same serving cell. A UE can use CG based SDT if at least the following criteria are fulfilled: (1) user data is smaller than a data volume threshold; (2) CG resource is configured and valid; (3) the UE has valid timing advance (TA).

As mentioned above, an association between CG resources and SSBs is required for multi-beam operation for CG-based SDT. One scheme is considered to send an explicit configuration of the association to a UE with a RRC Release message. A SS-RSRP (synchronization signals-reference signal received power) threshold can be configured for a SSB selection. A UE can select one of SSBs with SS-RSRP above the threshold. Then, a CG resource associated with the selected SSB can be selected for uplink data transmission.

CG PUSCH resources are the PUSCH resources configured in advance for a UE. In an example, when there is uplink data available at a UE's buffer, it can immediately start uplink transmission using the pre-configured PUSCH resources, without waiting for an uplink grant from a gNB, thus reducing the latency. NR supports CG type 1 PUSCH transmission and CG type 2 PUSCH transmission. For both two types, the PUSCH resources (e.g. time and frequency allocation, periodicity, etc.) are pre-configured via dedicated RRC signaling. The CG type 1 PUSCH transmission is activated/deactivated by an RRC signaling, while the CG type 2 PUSCH transmission is activated/deactivated by an uplink grant using downlink control information (DCI) signaling.

For example, in NR Rel-15, the CG period can be of following values depending on the CP configuration and the numerology:

### Periodicity

Periodicity for UL transmission without UL grant for type 1 and type 2 (see 3GPP TS 38.321 v16.2., clause 5.8.2).

The following periodicities (in symbols) are supported depending on the configured subcarrier spacing and CP (cyclic prefix) length:

TABLE 1
CG periods supported depending on subcarrier spacing and CP

| Subcarrier spacing | CG period (in symbols) |
|---|---|
| 15 kHz | 2, 7, n*14, where n = {1, 2, 4, 5, 8, 10, 16, 20, |
| | 32, 40, 64, 80, 128, 160, 320, 640} |
| 30 kHz | 2, 7, n*14, where n = {1, 2, 4, 5, 8, 10, 16, 20, 32, |
| | 40, 64, 80, 128, 160, 256, 320, 640, 1280} |
| 60 kHz with normal | 2, 7, n*14, where n = {1, 2, 4, 5, 8, 10, 16, 20, 32, |
| CP (cyclic prefix) | 40, 64, 80, 128, 160, 256, 320, 512, 640, 1280, 2560} |
| 60 kHz with | 2, 6, n*12, where n = {1, 2, 4, 5, 8, 10, 16, 20, 32, |
| extended CP | 40, 64, 80, 128, 160, 256, 320, 512, 640, 1280, 2560} |
| 120 KHz | 2, 7, n*14, where n = {1, 2, 4, 5, 8, 10, 16, 20, 32, |
| | 40, 64, 80, 128, 160, 256, 320, 512, 640, 1024, |
| | 1280, 2560, 5120} |

In NR Rel-16, a new parameter “periodicityExt-r16” has been introduced to calculate the periodicity for UL transmission without UL grant for type 1 and type 2 (see TS 38.321 V 16.2.0, clause 5.8.2). If this field is present, the field “periodicity” is ignored. The following periodicities (in symbols) are supported depending on the configured subcarrier spacing and CP length:

TABLE 2
CG periods supported depending on subcarrier spacing and CP

| Subcarrier spacing | CG period (in symbols) |
|---|---|
| 15 KHz | periodicityExt*14, where periodicityExt |
| | has a value between 1 and 640. |
| 30 kHz | periodicityExt*14, where periodicityExt |
| | has a value between 1 and 1280. |
| 60 kHz with normal | periodicityExt*14, where periodicityExt |
| CP (cyclic prefix) | has a value between 1 and 2560. |
| 60 kHz with | periodicityExt*12, where periodicityExt |
| extended CP | has a value between 1 and 2560. |
| 120 KHz | periodicityExt*14, where periodicityExt |
| | has a value between 1 and 5120. |

When PUSCH resource allocation is semi-statically configured by a higher layer parameter configuredGrantConfig in BWP-UplinkDedicated information element, and the PUSCH transmission corresponding to a configured grant, the following higher layer parameters are applied in the transmission:
For Type 1 PUSCH transmissions with a configured grant, the following parameters are given in configuredGrantConfig unless mentioned otherwise:
   For the determination of the PUSCH repetition type, if the higher layer parameter pusch-RepTypeIndicator-r16 in rm-ConftguredUplinkGrant is configured and set to ‘pusch-RepTypeB’, PUSCH repetition type B is applied; otherwise, PUSCH repetition type A is applied;
   For PUSCH repetition type A, the selection of the time domain resource allocation table follows the rules for DCI format 0_0 on UE specific search space, as defined in Clause 6.1.2.1.1 of TS38.214 V16.3.0.
   For PUSCH repetition type B, the selection of the time domain resource allocation table is as follows:
      If pusch-RepTypeIndicatorForDCI-Format0-1-r16 in pusch-Config is configured and set to ‘pusch-RepTypeB’, PUSCH-TimeDomainResourceAllocationList-ForDCIformat0_1 in pusch-Config is used;
      Otherwise, PUSCH-TimeDomainResourceAllocationList-ForDCIformat0_2 in pusch-Config is used.
      It is not expected that pusch-RepTypeIndicator-r16 in rrc-ConfiguredUplinkGrant is configured with ‘pusch-RepTypeB’ when none of pusch-RepTypeIndicatorForDCI-Format0-1-r16 and pusch-RepTypeIndicatorForDCI-Format0-2-r16 in pusch-Config is set to ‘pusch-RepTypeB’.
   The higher layer parameter timeDomainAllocation value m provides a row index m+1 pointing to the determined time domain resource allocation table, where the start symbol and length are determined following the procedure defined in Clause 6.1.2.1 of TS38.214 V16.3.0;
   Frequency domain resource allocation is determined by the N LSB bits in the higher layer parameter frequencyDomainAllocation, forming a bit sequence f₁₇, . . . , f₁, f₀, where f₀ is the LSB, according to the procedure in Clause 6.1.2.2 of TS38.214 V16.3.0 and N is determined as the size of frequency domain resource assignment field in DCI format 0_1 for a given resource allocation type indicated by resourceAllocation, except if useInterlacePUCCH-PUSCH in BWP-UplinkDedicated is configured, in which case uplink type 2 resource allocation is used wherein the UE interprets the LSB bits in the higher layer parameter frequencyDomainAllocation as for the frequency domain resource assignment field of DCI 0_1 according to the procedure in Clause 6.1.2.2.3 of TS 38.214 V16.3.0;
   The I_{MCS} is provided by higher layer parameter mcsAndTBS;
   Number of DM-RS CDM groups, DM-RS ports, SRS resource indication and DM-RS sequence initialization are determined as in Clause 7.3.1.1.2 of TS 38.212 V16.3.0, and the antenna port value, the bit value for DM-RS sequence initialization, precoding information and number of layers, SRS resource indicator are provided by antennaPort, dmrs-SeqInitialization, precodingAndNumberOfLayers, and srs-ResourceIndicator respectively;
   When frequency hopping is enabled, the frequency offset between two frequency hops can be configured by higher layer parameter frequencyHoppingOffset.
For Type 2 PUSCH transmissions with a configured grant: the resource allocation follows the higher layer configuration according to TS 38.321 V16.2.0, and UL grant received on the DCI.
   The PUSCH repetition type and the time domain resource allocation table are determined by the PUSCH repetition type and the time domain resource allocation table associated with the UL grant received on the DCI, respectively, as defined in Clause 6.1.2.1 of TS38.214 V16.3.0.

Beamforming is important for improving the coverage of synchronization signals (SSs) and physical broadcast channel (PBCH) block (referred to as SSB in 3GPP) transmission, especially for compensating the high path loss in high carrier frequency bands. To support beamforming and beam-sweeping for SSB transmission, in NR, a cell can transmit multiple SSBs in different narrow-beams in a time multiplexed fashion. The transmission of these SS/PBCH blocks is confined to a half frame time interval (5 ms). FIG. 1 illustrates an example of SSB beam sweeping when the system is operating at frequency range 1 (FR 1).

The maximum number of SSBs within a half frame (i.e., 5 ms), denoted by L, depends on the frequency band, and it is defined as follows:
For carrier frequencies smaller than or equal to 3 GHz, L=4;
For carrier frequencies within FR1 larger than 3 GHz, L=8;
For carrier frequencies within FR2, L=64.

PUSCH repetition is supported for transmission in PUSCH. In this regard, slot aggregation for PUSCH is supported in NR Rel-15 and renamed to PUSCH Repetition Type A in NR Rel-16. The name PUSCH repetition Type A is used even if there is only a single repetition, i.e. no slot aggregation. In NR Rel-15, a PUSCH transmission that overlaps with downlink (DL) symbols is not transmitted.

For DCI granted multi-slot transmission (e.g. in Physical Downlink Shared Channel (PDSCH) or PUSCH) when a semi-static TDD (Time Division Duplexing) downlink/uplink (DL/UL) assignment is configured,
If semi-static DL/UL assignment configuration of a slot has no direction confliction with scheduled PDSCH/PUSCH assigned symbols, the PDSCH/PUSCH in that slot is received/transmitted;
If semi-static DL/UL assignment configuration of a slot has direction confliction with scheduled PDSCH/PUSCH assigned symbols, the PDSCH/PUSCH transmission in that slot is not received/transmitted, i.e. the effective number of repetitions reduces.

In NR Rel-15, the number of repetitions is semi-statically configured by an RRC parameter pusch-AggregationFactor. At most 8 repetitions are supported. For example, the parameter pusch-AggregationFactor can be defined as follows:

pusch-AggregationFactor ENUMERATED {n2, n4, n8}

A new repetition format, namely PUSCH repetition Type B, is supported in NR Rel-16, which allows back-to-back repetition of PUSCH transmissions. The main difference between the two types of repetition is that repetition Type A only allows a single repetition in each slot, with each repetition occupying the same symbols within the slot. Using this repetition of Type A, when a PUSCH repetition has a number of symbols shorter than 14 symbols, it introduces gaps between repetitions, increasing the overall latency.

Another change in NR Rel-16 compared to NR Rel-15 is how the number of repetitions is signaled. In NR Rel-15, the number of repetitions is semi-statically configured, while in NR Rel-16 the number of repetitions can be indicated dynamically in DCI. This applies both to dynamic grants and configured grants Type 2.

In NR Rel-16, invalid symbols for PUSCH repetition Type B include reserved uplink (UL) resources. The invalid symbol pattern indicator field is configured in the scheduling DCI. Segmentation occurs around symbols that are indicated as DL by the semi-static TDD pattern and invalid symbols.

Some signaling of a number of PUSCH repetitions can be specified in standard specifications as follows.

For example, in TS 38.214 V16.3.0, for PUSCH repetition Type A, when transmitting PUSCH scheduled by DCI format 0_1 or 0_2 in PDCCH with CRC (Cyclic Redundancy Check) scrambled with C-RNTI (Cell-Radio Network Temporary Identifier), MCS-C-RNTI (Modulation and Coding Scheme—Cell-RNTI), or CS-RNTI (Configured Scheduling-RNTI) with NDI (New Data Indicator)=1, the number of repetitions K is determined as
if numberofrepetitions is present in the resource allocation table, the number of repetitions K is equal to numberofrepetitions;
else if the UE is configured with pusch-AggregationFactor, the number of repetitions K is equal to pusch-AggregationFactor;
otherwise K=1.

In TS 38.212 V16.3.0, the number of PUSCH repetitions is indicated by a DCI format 0_1 as follows:

Time domain resource assignment—0, 1, 2, 3, 4, 5, or 6 bits
If the higher layer parameter PUSCH-TimeDomainResourceAllocationList-ForDCIformat0_1 is not configured and if the higher layer parameter pusch-TimeDomainAllocationList is configured, 0, 1, 2, 3, or 4 bits as defined in Clause 6.1.2.1 of [6, TS38.214]. The bitwidth for this field is determined as ┌log₂(I)┐ bits, where I is the number of entries in the higher layer parameter pusch-TimeDomainAllocationList or pusch-TimeDomainAllocationList-r16;
If the higher layer parameter PUSCH-TimeDomainResourceAllocationList-ForDCIformat0_is configured, 0, 1, 2, 3, 4, 5 or 6 bits as defined in Clause 6.1.2.1 of [6, TS38.214]. The bitwidth for this field is determined as ┌log₂(I)┐ bits, where I is the number of entries in the higher layer parameter PUSCH-TimeDomainResourceAllocationList-ForDCIformat0_1;
otherwise the bitwidth for this field is determined as ┌log₂(I)┐ bits, where I is the number of entries in the default table.

In TS38.331 V16.2.0, the number of PUSCH repetitions is indicated by a PUSCH-Config information element or a PUSCH-TimeDomainResourceAllocation information element as follows:

PUSCH-Config information element

```
pusch-TimeDomainAllocationList  SetupRelease { PUSCH-TimeDomainResourceAllocationList }  OPTIONAL, --
Need M
pusch-AggregationFactor  ENUMERATED { n2, n4, n8 }  OPTIONAL, -- Need S
...
pusch-TimeDomainAllocationListDCI-0-2-r16  SetupRelease { PUSCH-TimeDomainResourceAllocationList-r16 }
    OPTIONAL, -- Need M
...
  pusch-TimeDomainAllocationListDCI-0-1-r16  SetupRelease { PUSCH-TimeDomainResourceAllocationList-r16 }
    OPTIONAL, -- Need M
```

PUSCH-TimeDomainResourceAllocation information element

```
-- ASN1START
-- TAG-PUSCH-TIMEDOMAINRESOURCEALLOCATIONLIST-START
PUSCH-TimeDomainResourceAllocationList ::=  SEQUENCE (SIZE(1..maxNrofUL-Allocations)) OF PUSCH-
TimeDomainResourceAllocation
PUSCH-TimeDomainResourceAllocation ::= SEQUENCE {
    k2  INTEGER(0..32) OPTIONAL, -- Need S
    mapping Type  ENUMERATED {ypeA, typeB},
    startSymbolAndLength INTEGER (0..127)
}
PUSCH-TimeDomainResourceAllocationList-r16 ::=  SEQUENCE (SIZE(1..maxNrofUL-Allocations-r16)) OF PUSCH-
TimeDomainResourceAllocation-r16
PUSCH-TimeDomainResourceAllocation-r16 ::=  SEQUENCE {
    k2-r16 INTEGER(0..32) OPTIONAL, -- Need S
    puschAllocationList-r16 SEQUENCE (SIZE(1..maxNrofMultiplePUSCHs-r16)) OF PUSCH-Allocation-r16,
    ...
}
PUSCH-Allocation-r16 ::= SEQUENCE {
    mappingType-r16 ENUMERATED {typeA, typeB} OPTIONAL, -- Cond NotFormat01-02-Or-TypeA
    startSymbolAndLength-r16 INTEGER (0..127) OPTIONAL, -- Cond NotFormat01-02-Or-TypeA
    startSymbol-r16  INTEGER (0..13) OPTIONAL, -- Cond RepTypeB
    length-r16 INTEGER (1..14) OPTIONAL, -- Cond RepTypeB
    numberOfRepetitions-r16 ENUMERATED {n1, n2, n3, n4, n7, n8, n12, n16} OPTIONAL,  -- Cond Format01-02
    ...
}
-- TAG-PUSCH-TIMEDOMAINRESOURCEALLOCATIONLIST-STOP
-- ASN1STOP
maxNrofUL-Allocations INTEGER ::= 16 -- Maximum number of PUSCH time domain resource allocations.
maxNrofUL-Allocations-r16 INTEGER ::= 64 -- Maximum number of PUSCH time domain resource allocations
```

This disclosure provides different schemes for configuring CG PUSCH resources for uplink transmissions in a non-RRC connected state, where the CG PUSCH resources are needed for CG-based SDT, and can be mapped to SSBs. The CG based transmission can be performed in PUSCH (physical uplink shared channel), such as CG type 1 PUSCH transmission. In this disclosure, the term “CG PUSCH resource”, also known as “CG resource” or “CG configured PUSCH resource”, means the time, frequency and DMRS resources configured in a configured grant for PUSCH transmissions.

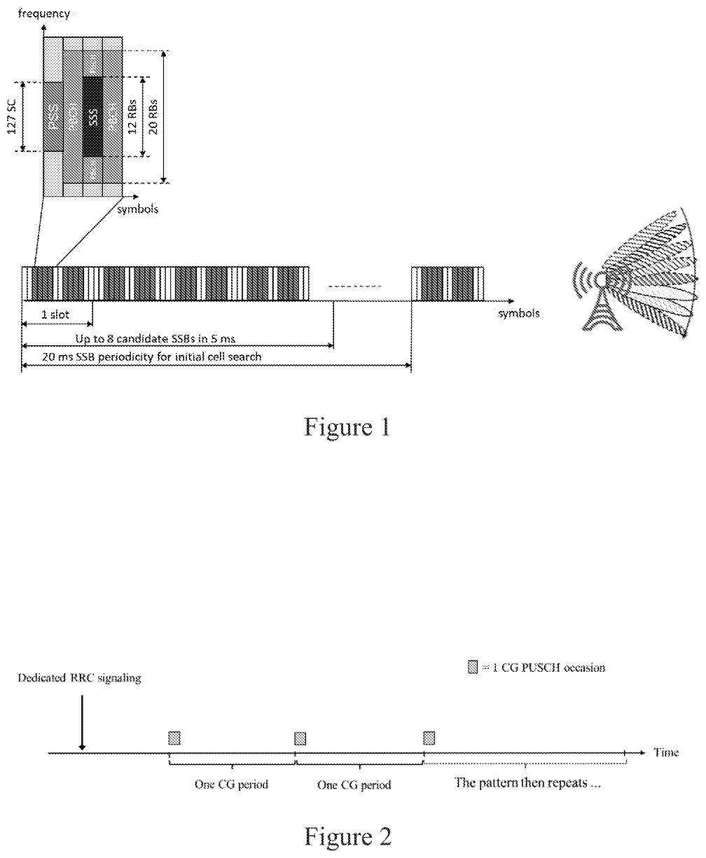

FIG. 2 illustrates an example of PUSCH resources pre-configured by using CG type 1 scheme. As shown in FIG. 2, PUSCH occasions (i.e. time resources and/or frequency resources) allocated for the CG based transmission is periodic. For CG based transmission, the PUSCH resources are pre-configured (e.g. time and frequency allocation, settings of periodicity for UL transmission, etc.) via a dedicated RRC signaling. The RRC signaling may be an RRC release message. In this disclosure, the term “RRC release message” means a message sent to a UE to release an RRC connection so that the UE will move from an RRC connected state to another different RRC state (referred to as non-RRC connected state herein). In this disclosure, the term “non-RRC connected state” means a kind of RRC state for a UE, in which the UE is not in RRC connected state. For example, the non-RRC connected state may be either RRC idle state or RRC inactive state.

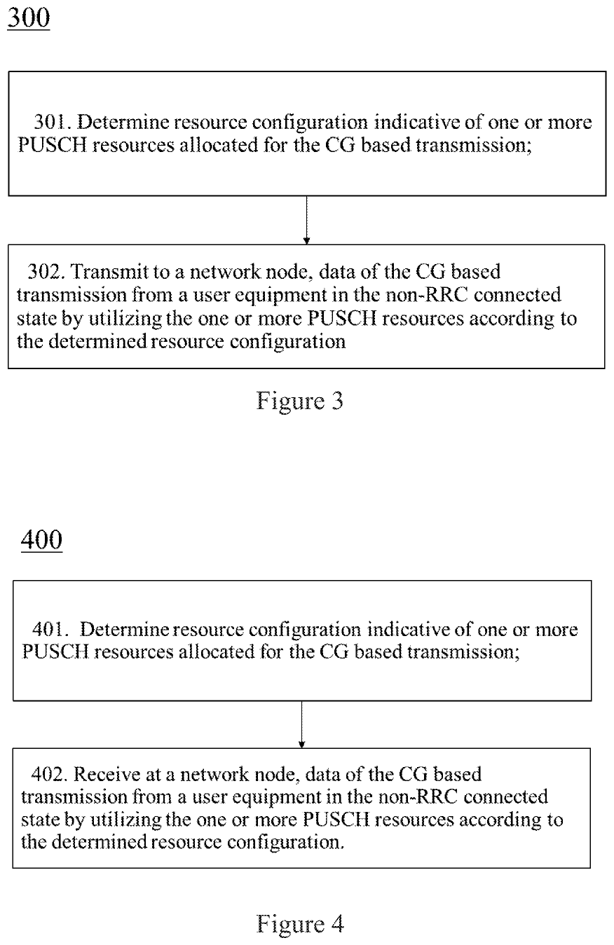

FIG. 3 illustrates a flowchart of a method 300 for CG based transmission at a user equipment (e.g. UE), according to some embodiments of the present disclosure. As shown in FIG. 3, the method 300 comprises determining resource configuration indicative of one or more PUSCH resources allocated for the CG based transmission, as shown at block 301; and transmitting to a network node (e.g. a gNB), data of the CG based transmission from the user equipment in the non-RRC connected state by utilizing the one or more PUSCH resources according to the determined resource configuration, as shown at block 302.

In some embodiments, the resource configuration may be received from the network node via an RRC signaling. In some other embodiments, the resource configuration may be determined by the user equipment, based on a default allocation list of time domain resources which is predefined for the CG based transmission in the non-RRC connected state. The default allocation list of time domain resources may be a time domain resource allocation (TDRA) table.

FIG. 4 illustrates a flowchart of a method for CG based transmission at a network node, e.g., a gNB, according to some embodiments of the present disclosure. As shown in FIG. 4, the method 400 comprises: determining resource configuration indicative of one or more PUSCH resources allocated for the CG based transmission as shown at block 401; and receiving at the network node, data of the CG based transmission from a user equipment in the non-RRC connected state by utilizing the one or more PUSCH resources according to the determined resource configuration, as shown at block 402.

Although not shown, in some embodiments, the method 400 may further comprise: transmitting to the user equipment, an RRC signaling indicative of the resource configuration.

In some embodiments, the CG based transmission in the methods 300 and 400 may be SDT for a user equipment in RRC_INACTIVE state. It should be appreciated that the CG based transmission can be other kinds of transmission based on CG for a user equipment which is not in RRC connected states.

According to embodiments in this disclosure, PUSCH resources can be allocated and/or configured for a UE to transmit uplink small data in the RRC inactive state based on configured grant.

In NR Rel-15 and Rel-16, the information element (IE) ConfiguredGrantConfig is used to configure uplink transmission without dynamic grant according to two possible schemes. The actual uplink grant may either be configured via RRC (type1) or provided via the PDCCH (addressed to CS-RNTI) (type2). Multiple Configured Grant configurations may be configured in one bandwidth part (BWP) of a serving cell.

The following parameters in IE ConfiguredGrantConfig are related to the time domain resource configuration for CG-based PUSCH transmissions. For example, the following parameters as specified in TS 38.331 V16.2.0:
timeDomainAllocation: INTEGER (0 . . . 15), indicates a combination of start symbol and length and PUSCH mapping type, (e.g. see TS 38.214 V16.3.0, clause 6.1.2 and TS 38.212 V16.3.0, clause 7.3.1).
repK: ENUMERATED {n1, n2, n4, n8}, indicates number of repetitions. For CG type 1 PUSCH transmission, the number of repetitions K is determined by the parameter “numberOfRepetitions_r16” if it is present in the time domain resource allocation table, otherwise, the number of repetitions K is determined by “repK”.
pusch-RepTypeIndicator-r16: ENUMERATED {pusch-RepTypeA, pusch-RepTypeB}, indicates whether UE follows the behavior for PUSCH repetition type A or the behavior for PUSCH repetition type B for each Type 1 configured grant configuration. The value pusch-RepTypeA enables the ‘PUSCH repetition type A’ and the value pusch-RepTypeB enables the ‘PUSCH repetition type B’ (e.g. see TS 38.214 V16.3.0, clause 6.1.2.3).
cg-nrofSlots-r16: INTEGER (1 . . . 40), indicates the number of consecutive slots allocated within a configured grant periodicity.
cg-nrofPUSCH-InSlot: INTEGER (1 . . . 7), indicates the number of consecutive PUSCH allocations within a slot, where the first PUSCH allocation follows the higher layer parameter timeDomainAllocation for Type 1 PUSCH transmission, and the remaining PUSCH allocations have the same length and PUSCH mapping type, and are appended following the previous allocations without any gaps. The same combination of start symbol and length and PUSCH mapping type repeats over the consecutively allocated slots.
frequencyDomainAllocation: indicates the frequency domain resource allocation.

In some embodiments, the resource configuration of the PUSCH resources can be determined from an allocation list of time domain resources defined for a CG based transmission in a non-RRC connected state. For example, the allocation list may be defined as a time domain resource allocation (TDRA) table, which can be indicated to a UE in a dedicated RRC signaling used for moving the UE from an RRC connected state to an RRC inactive state. As an example, the RRC signaling is an RRC release message.

In one example, a TDRA table is defined by an IE pusch-TimeDomainAllocationList in the RRC release message for PUSCH repetition type A. In another example, a TDRA table is defined by a higher layer parameter PUSCH-TimeDomainResourceAllocationList-ForDCIformat0_1 and/or PUSCH-TimeDomainResourceAllocationList-ForDCIformat0_2 in the RRC release message for PUSCH repetition type B.

In an embodiment, the UE can receive the allocation list in an RRC signaling from the gNB. The TDRA table is indicated by at least one of the following parameters in the RRC signaling: a higher layer parameter indicative of information on configured uplink grant, a higher layer parameter indicative of information on CG configuration, and a higher layer parameter indicative of information on PUSCH configuration. For example, at least one TDRA table can be added in a higher layer parameter rrc-ConfiguredUplinkGrant_r17 in an RRC release message. Alternatively or additionally, at least one TDRA table can be added in a higher layer parameter ConfiguredGrantConfig_r17 in an RRC release message. Alternatively or additionally, at least one TDRA table can be added in a higher layer parameter pusch-config_r17 in an RRC release message.

In an embodiment, one or more default TDRA tables can be specified, e.g. in a table of a 3GPP specification, for CG based transmission in an RRC inactive state. The default TDRA tables can be existing default TDRA tables (e.g. TDRA tables in the specification TS38.214 v16.3.0), or newly defined default tables. As an example shown in table 3, a separate TDRA table can be specified for CG based SDT.

TABLE 3
Default PUSCH time domain resource
allocation for CG-based SDT

| | PUSCH | | |
|---|---|---|---|
| Row index | mapping type | S | L |
| 1 | Type A | 0 | 14 |
| 2 | Type A | 0 | 12 |
| 3 | Type A | 0 | 10 |
| 4 | Type B | 2 | 10 |
| 5 | Type B | 4 | 10 |
| 6 | Type B | 4 | 8 |
| 7 | Type B | 4 | 6 |
| 8 | Type A | 0 | 14 |
| 9 | Type A | 0 | 12 |
| 10 | Type A | 0 | 10 |
| 11 | Type A | 0 | 14 |
| 12 | Type A | 0 | 12 |
| 13 | Type A | 0 | 10 |
| 14 | Type B | 8 | 6 |
| 15 | Type A | 0 | 14 |
| 16 | Type A | 0 | 10 |

In table 3, S represents a starting symbol relative to the start of a slot, and L represents a number of symbols allocated for the CG based transmission in a slot. The symbols allocated for the CG based transmission may be consecutive symbols.

Either a UE or a gNB can determine a TDRA table to be used for the CG based transmission in an RRC inactive state by themself. In an example, one specific default TDRA table is predetermined for the CG based transmission of a UE in an RRC inactive state. In another example, the UE and gNB can determine which default TDRA table among multiple default TDRA tables would be used for the CG based transmission in an RRC inactive state, e.g. based on a predefined rule.

In an embodiment, the allocation list is a reuse of at least one allocation list of time domain resources of PUSCH configured for transmission in an RRC connected state. For example, the allocation list can be a TDRA table configured by an RRC signaling for PUSCH transmission when the UE is in an RRC connected state. In this regard, at least part of the PUSCH resources allocated to the UE in an RRC connected state would be reused for its PUSCH transmission in RRC inactive state.

One or more of the allocation lists of time domain resources mentioned in above different embodiments can be supported. For example, there may be multiple TDRA tables provided to a UE in an RRC signaling or in a system message (e.g. a push-ConfigCommon message). The UE can select one allocation list of time domain resources from the multiple allocation lists of time domain resources, for its CG based transmission in the non-RRC connected state. The selection can be made based on a predetermined rule. In an example, a selection rule for a TDRA table to be used for CG based transmission in an RRC inactive state is defined as:
If a TDRA table is provided in an RRC release message, then the UE should select the table provided in the RRC release message,
else if a TDRA table is provided in a pusch-ConfigCommon message, then the UE select the table defined in pusch-ConfigCommon.
Else the UE selects a default TDRA table.

When multiple TDRA tables are defined, which one to be selected by a UE for CG PUSCH transmission in RRC Inactive state can be determined at the network side based on a same/corresponding predetermined rule.

In some embodiments, one or more of parameters of the allocation list of time domain resources can be transmitted from a gNB to a UE in an RRC signaling. For example, the parameters can be comprised explicitly in a dedicated RRC signaling, e.g. an RRC release message. The parameters can comprise at least one of a starting symbol relative to the start of a slot (denoted as S); a number of symbols allocated for the CG based transmission in a slot (denoted as L); a PUSCH mapping type; and a number of PUSCH repetitions. For example, there may be 14 symbols in a slot, and S may be a symbol index (e.g. one of index 0, . . . , 13) of the first symbol allocated to a PUSCH occasion in a certain slot. L may represent how many consecutive symbols are used for this PUSCH occasion from the starting symbol S.

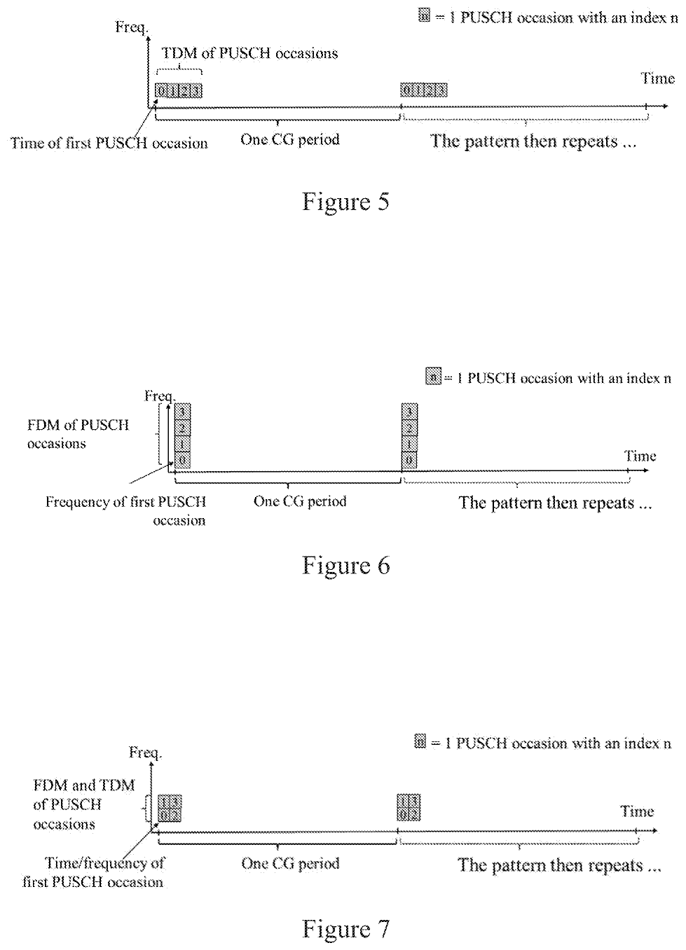

In some embodiments, only one PUSCH occasion per CG period is allocated for a CG based transmission in a non-RRC connected state, e.g. as shown in FIG. 1. In some other embodiments, multiple PUSCH occasions per CG period are configured for the CG based transmission in the non-RRC connected state, e.g. to support mapping of multiple SSBs to different CG PUSCH resources within a CG period. This can be achieved by configuring multiple PUSCH occasions in the time domain within a CG period, or configurating multiple PUSCH occasions in the frequency domain within a CG period, or the combination of both. FIG. 5 illustrates an example in which multiple PUSCH occasions in the time domain within a CG period are allocated for a CG based transmission. FIG. 6 illustrates an example in which multiple PUSCH occasions in the frequency domain within a CG period are allocated for a CG based transmission. FIG. 7 illustrates an example in which multiple PUSCH occasions in both the time domain and the frequency domain within a CG period are allocated for a CG based transmission.

The multiple PUSCH occasions in the time domain per CG period can be configured by different methods. In a first option, the time domain resource configuration for PUSCH occasions per CG period for UL transmission in an RRC inactive state is configured by at least one of the following parameters: a number of slots containing the one or multiple PUSCH occasions (e.g. nrofSlots-PUSCH-r17) per CG period, and a number of PUSCH occasions configured to the CG based transmission in a slot (e.g. nrof-PO-Perslot-r17). Each slot has a same time domain resource allocation. The PUSCH occasions configured to the CG based transmission in a slot can be consecutive PUSCH occasions, or are separated with a fixed gap. In this case, the total number of PUSCH occasions per CG period in time domain can be calculated as nrofSlots-PUSCH-r17 multiply with nrof-PO-Perslot-r17. The validation of PUSCH occasions can follow the legacy rules.

In a second option, the multiple PUSCH occasions in the time domain per CG period can be configured with a parameter indicating a total number of the multiple PUSCH occasions in the time domain per CG period. For example, the parameter may be nrof-PO-PerCGperiod-TDM-r17, and a value of the parameter denotes the total number of PUSCH occasions multiplexed in the time domain per CG period.

In some embodiments, the multiple PUSCH occasions in the time domain per CG period are configured based on a PUSCH repetition type for the CG based transmission. Take the second option as an example. If the PUSCH repetition type is Type A (e.g. the higher layer parameter “pusch-RepTypeIndicator-r16” is set to “pusch-RepTypeA”), time allocation (comprising a start symbol and a length) for the nrof-PO-PerCGperiod-TDM-r17 PUSCH occasions can be determined by using the PUSCH repetition type A method, e.g. as described in section 6.1.2.1 of TS 38.214 V16.3.0. That is, the PUSCH occasions in the time domain are configured in nrof-PO-PerCGperiod-TDM-r17 consecutive slots, with a single PUSCH occasion configured per slot. And the same symbol allocation is applied across the nrof-PO-PerCGperiod-TDM-r17 consecutive slots.

Otherwise, i.e. if the PUSCH repetition type is Type B (e.g. the higher layer parameter “pusch-RepTypeIndicator-r16” is set to “pusch-RepTypeB”), the time allocation (start symbol and length) for the nrof-PO-PerCGperiod-TDM-r17 consecutive PUSCH occasions are determined by using the PUSCH repetition type B method, e.g. as described in section 6.1.2.1 of TS 38.214 V16.3.0, by replacing the parameter “numberOfRepetitions-r16” with “nrof-PO-PerCGperiod-TDM-r17” and replacing the term “nominal repetition” with “nominal transmission” which means a scheduled transmission that may not be an actual transmission. All PUSCH occasions have the same length and PUSCH mapping type. That is, for PUSCH repetition Type B, the starting symbol S relative to the start of the slot, and the number of consecutive symbols L counting from the symbol S allocated for the PUSCH are provided by the start symbol and number of symbols of the indexed row of the resource allocation table, respectively. And the PUSCH mapping type is set to Type B. For PUSCH repetition Type B, the number of nominal repetitions is given by nrof-PO-PerCGperiod-TDM-r17. For the n-th nominal repetition, n=0, . . . , (nrof-PO-PerCGperiod-TDM-r17−1), the slot where the nominal transmission starts is given by

$${K}_{s} + ⌊ \frac{S + n \cdot L}{{N}_{symb}^{slot}} ⌋ ,$$

and the starting symbol relative to the start of the slot is given by mod(S+n·L,N_{symb}^{slot}); the slot where the nominal transmission ends is given by

$${K}_{s} + ⌊ \frac{S + ( n + 1 ) \cdot L - 1}{{N}_{symb}^{slot}} ⌋ ,$$

and the ending symbol relative to the start of the slot is given by mod(S+(n+1)·L−1,N_{symb}^{slot}). Here K, is the slot where the first PUSCH transmission starts, and N_{symb}^{slot} is the number of symbols per slot.

In some embodiments, for both two options, the time allocation for the first PUSCH occasion per CG period can be determined by utilizing one or more of the following manners. In a manner, the starting symbol (S) and length (L) of the first PUSCH occasion per CG period is determined by a higher layer parameter (e.g. timeDomainAllocation) indicative of information on allocation of time domain resources and/or a selected TDRA table. In another manner, the starting symbol (S) and length (L) of the first PUSCH occasion per CG period are signaled explicitly in an RRC signaling, such as an RRC release message.

In some embodiments, for both two options, the number of configured PUSCH occasions per CG period can be configured to support PUSCH repetition. In this regard, a total number of the multiple PUSCH occasions in the time domain per CG period is configured to be divisible by a number of supported PUSCH repetitions. For example, if PUSCH repetition is supported, the number of PUSCH repetition (denoted as K), is larger than 1. Then, the total number of PUSCH occasions per CG period is configured such that it can be divisible by K.

When the uplink bandwidth is enough to support configuring multiple PUSCH occasions in the frequency domain, more than one PUSCH occasions can be multiplexed in the frequency domain at a time instance. In an embodiment, the multiple PUSCH occasions in the frequency domain per CG period are configured with a parameter (e.g. nrof-PO-PerCGperiod-FDM-r17) indicating a total number of the multiple PUSCH occasions in the frequency domain per CG period. As an example of the configuration, the frequency allocation for the first PUSCH occasion in the frequency domain, i.e., the lowest PUSCH transmission occasion in frequency domain, is defined by the higher layer parameter, e.g. frequencyDomainAllocation. All the PUSCH occasions are allocated with a same number of resource blocks (RBs) in the frequency domain. The nrof-PO-PerCGperiod-FDM-r17 PUSCH occasions multiplexed in the frequency domain can be continuous in frequency.

In another embodiment, the multiple PUSCH occasions in the frequency domain per CG period are configured with a gap between different PUSCH occasions multiplexed in the frequency domain. The gap can be either predetermined or configured by the network. This makes it more flexible to schedule multiple PUSCH occasions in frequency domain, especially when the required number of available PRBs are not consecutive.

In another embodiment, when frequency hopping is enabled, a same frequency offset between hops is used for frequency hopping for different PUSCH occasions multiplexed in the frequency domain. The frequency hopping can be intra-slot and/or inter-slot frequency hopping.

In some embodiments, the resource configuration for a CG based transmission in non-RRC connected state comprises determination of BWP for resource allocation in a frequency domain. In an example, the BWP used for CG PUSCH resource scheduling is predetermined. In this regard, the CG PUSCH resources configured for the transmission in a non-RRC connected state are allocated in a predetermined BWP. For example, the predetermined BWP can be at least one of an initial active BWP and a last BWP active before UE switches to RRC inactive state. Accordingly, a UE can determine the BWP to be used for CG based transmission in a non-RRC connected state by itself. In another example, a UE can receive from a network node, an RRC signaling indicative of a BWP configured for the CG PUSCH resources. For example, a BWP ID (identifier) or a specific BWP for a SDT can be configured in an RRC signaling, e.g. in an RRC release message. The specific BWP may be a new BWP specific for a SDT in RRC inactive state, which is additionally configured for the SDT in the RRC signaling. With these embodiments, it will be known to the UE and gNB, in which BWP the physical resource blocks (PRBs) for SDT transmissions are expected to be scheduled.

PUSCH repetition may be needed to make sure of a robust CG based transmission, since the resource for a retransmission of CG based PUSCH may be not available until another CG period, especially when the number of PUSCH occasions in one CG period is small. In one embodiment, both repetition type A and repetition type B are supported for CG-based SDT on PUSCH. With this method, when a latency is required to be short for SDT, a repetition type B can be used. When a latency requirement is not so important, a PUSCH repetition of type A can be configured.

In another embodiment, only repetition type A is supported. This limitation can reduce the complexity and signaling overhead for scheduling for a UE in an RRC inactive state. This would be benefit when a UE executes a small data transmission and when a latency is not critical.

In some embodiments, when a PUSCH repetition is used, different repetitions can be mapped to different SSBs. In this regard, a UE can determine one or more SSBs, and then determine one or more PUSCH repetitions mapped to the determined one or more SSBs, e.g. according to a mapping rule for mappings between PUSCH repetitions and SSBs. Then, data of the CG based transmission can be transmitted with PUSCH resources of the determined one or more PUSCH repetition. Accordingly, a gNB can determine the PUSCH repetitions utilized for the CG based transmission, and determine the SSBs mapped to the determine the PUSCH repetitions according to the mapping rule. These embodiments enable a beam sweeping on different CG PUSCH repetitions, so that the CG PUSCH performance can be further improved on top of the gain from repetitions in a time domain.

Current specification supports a maximum 640 ms CG period for a normal CG based transmissions when a UE is in an RRC connected state. For small data transmission in an RRC inactive state, if the CG period is too small, it will cause much higher resource overhead and a higher complexity of a network receiver, especially when the small data is not transmitted so frequently. Thus, it would be desirable to extend or enlarge the CG period. In an embodiment, an extended CG period is determined by a time offset added to a normal CG period. For example, a time offset may be one second. By adding the time offset to the CG periods supported in NR Rel-15 and Rel-16, the CG period can be extended, up to 1640 ms. The time offset can be a predetermined value, or be configured by a network node. In another embodiment, an extended CG period is determined by a newly defined CG period value compared to supported CG periods. In this regard, one or more additional or separate candidate CG period values can be defined compared to the CG periods supported, in NR Rel-15 and Rel-16 for example. With these embodiments, an extended CG period can be used, so that there will be less resource overhead reserved for CG PUSCH, which will require frequent receptions on each candidate CG PUSCH occasions and is not necessary when the SDT does not happen so frequently.

In some embodiments, the resource configuration comprises one or more SSB indexes to be used for association with the CG based transmission in the non-RRC connected state. The SSB indexes can be indicated by a higher layer parameter, which is introduced in an RRC signaling. As an example, the RRC signaling can be in an RRC release message used for moving a UE from an RRC connected state to an RRC inactive state. In an embodiment, an SSB associated to the PUSCH resources to be used by the CG based transmission is always determined by the higher layer parameter indicating one or more SSB indexes. In this regard, a UE can receive from a gNB, an RRC signaling which comprises a parameter indicating the SSB indexes, and then determine one or more SSBs associated to the PUSCH resources to be used for CG based transmission in the non-RRC connected state according to the parameter. In another embodiment, if the higher layer parameter indicating the one or more SSB indexes presents in the RRC message used for CG based PUSCH in RRC inactive, the SSB associated to PUSCH resources for the CG based transmission is determined by this higher layer parameter when configured. Otherwise, the selected SSB for a CG based transmission is determined by according to mappings between a set of SSBs and a set of PUSCH resources. The mappings define an association between SSBs and CG PUSCH resources in advance.

This disclosure provides different methods for configuring CG PUSCH resources for uplink transmissions in RRC inactive state, which are needed for supporting multi-beam operation for CG based transmission with low complexity, flexible resource allocation, low resource overhead, and robust PUSCH transmissions.

It is noted that some embodiments of the present disclosure are mainly described in relation to 5G specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does not limit the present disclosure naturally in any way. Rather, any other system configuration or radio technologies may equally be utilized as long as exemplary embodiments described herein are applicable.

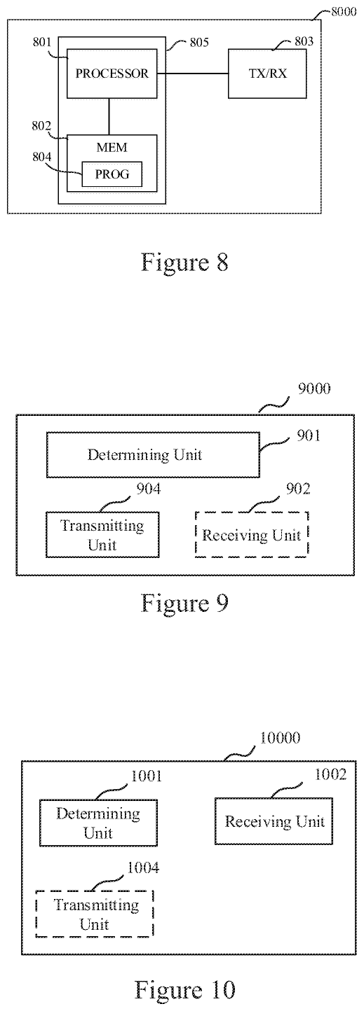

FIG. 8 illustrates a simplified block diagram of an apparatus 8000 that may be embodied in/as a terminal device (e.g., a UE), or a network node (e.g., a gNB). The apparatus 8000 may comprise at least one processor 801, such as a data processor (DP) and at least one memory (MEM) 802 coupled to the processor 801. The apparatus 8000 may further comprise a transmitter TX and receiver RX 803 coupled to the processor 801. The MEM 802 stores a program (PROG) 804. The PROG 804 may include instructions that, when executed on the associated processor 801, enable the apparatus 8000 to operate in accordance with the embodiments of the present disclosure, for example to perform one of the methods 300, 400. A combination of the at least one processor 801 and the at least one MEM 802 may form processing means 805 adapted to implement various embodiments of the present disclosure.

Various embodiments of the present disclosure may be implemented by computer program executable by one or more of the processors 801, software, firmware, hardware or in a combination thereof.

The MEMs 802 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 801 may be of any type suitable to the local technical environment, and may include one or more of general purpose computers, special purpose computers, microprocessors, digital signal processors DSPs and processors based on multicore processor architecture, as non-limiting examples.

Reference is now made to FIG. 9, which illustrates a schematic block diagram of apparatus 9000 in a terminal device, such as a UE. The apparatus 9000 is operable to carry out the exemplary methods 300 described with reference to FIG. 3, and possibly any other processes or methods.

As shown in FIG. 9, the apparatus 9000 may comprise: a determining unit 901, which is configured to determine resource configuration indicative of one or more PUSCH resources allocated for the CG based transmission. The apparatus 9000 further comprises a transmitting unit 904, which is configured to transmit to a network node, data of the CG based transmission from a user equipment in the non-RRC connected state by utilizing the one or more PUSCH resources according to the determined resource configuration.

In some embodiments, the apparatus 9000 may further comprise a receiving unit 902, which is configured to receive from a network node, an RRC signaling indicative of the resource configuration.

Reference is now made to FIG. 10, which illustrates a schematic block diagram of apparatus 1000 in a network node in a wireless communication network, such as a gNB. The apparatus 1000 is operable to carry out the exemplary method 400 described with reference to FIG. 4, respectively, and possibly any other processes or methods.

As illustrated in FIG. 10, the apparatus 10000 comprises a receiving unit 1002, which is configured to determine resource configuration indicative of one or more PUSCH resources allocated for the CG based transmission. The apparatus 10000 further comprises a determining unit 1001, which is configured to receive at a network node, data of the CG based transmission from a user equipment in the non-RRC connected state by utilizing the one or more PUSCH resources according to the determined resource configuration

In some embodiments, the apparatus 10000 may further comprise a transmitting unit 1004, which is configured to transmit to the user equipment, an RRC signaling indicative of the resource configuration.

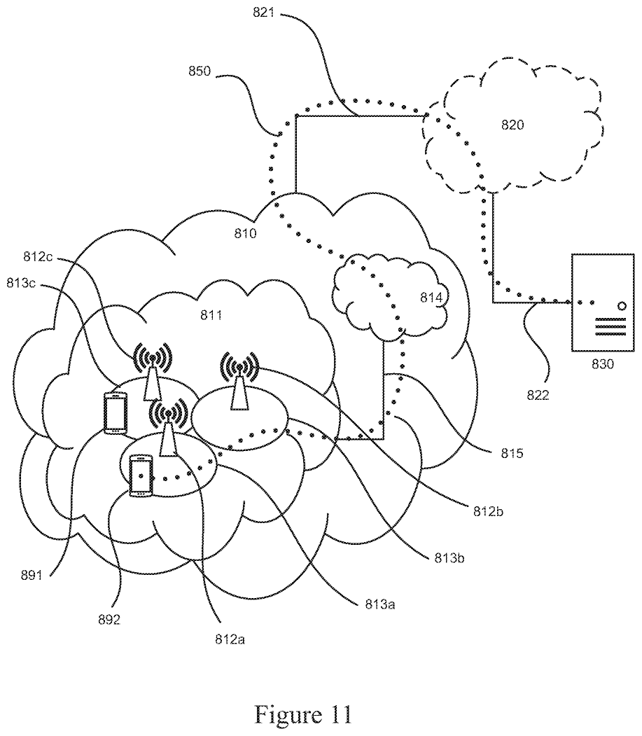

FIG. 11 is a block diagram illustrating a telecommunication network connected via an intermediate network to a host computer in accordance with some embodiments of the present disclosure.

With reference to FIG. 11, in accordance with an embodiment, a communication system includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first UE 891 located in a coverage area 813c is configured to wirelessly connect to, or be paged by, the corresponding base station 812c. A second UE 892 in a coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. Connections 821 and 822 between the telecommunication network 810 and the host computer 830 may extend directly from the core network 814 to the host computer 830 or may go via an optional intermediate network 820. An intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 11 as a whole enables connectivity between the connected UEs 891, 892 and the host computer 830. The connectivity may be described as an over-the-top (OTT) connection 850. The host computer 830 and the connected UEs 891, 892 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, the base station 812 may not or need not be informed about the past routing of an incoming downlink communication with data originating from the host computer 830 to be forwarded (e.g., handed over) to a connected UE 891. Similarly, the base station 812 need not be aware of the future routing of an outgoing uplink communication originating from the UE 891 towards the host computer 830.

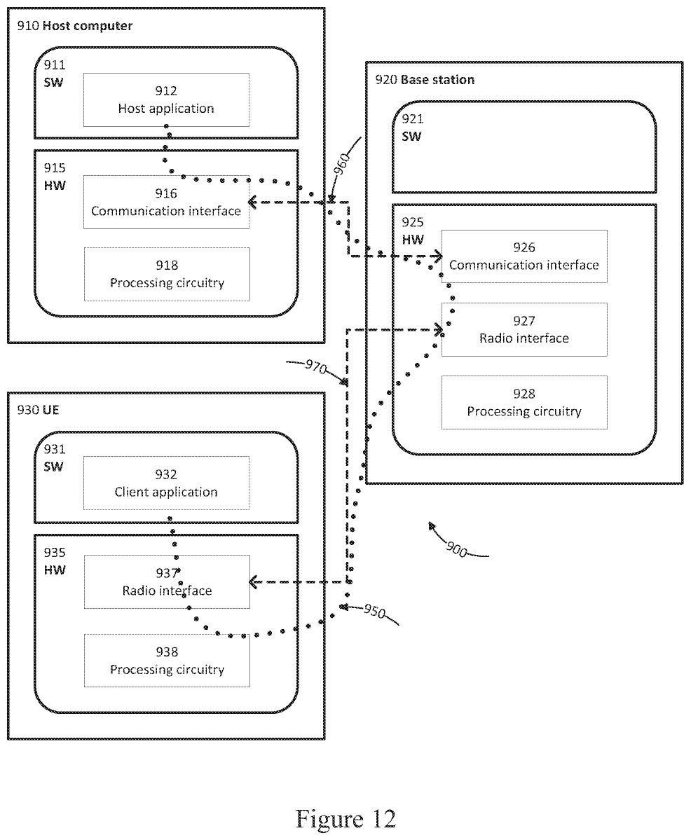

FIG. 12 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 12. In a communication system 900, a host computer 910 comprises hardware 915 including a communication interface 916 configured to set up and maintain a wired or wireless connection with an interface of a different communication device of the communication system 900. The host computer 910 further comprises a processing circuitry 912, which may have storage and/or processing capabilities. In particular, the processing circuitry 912 may comprise one or more programmable processors, application-specific integrated circuits, field programmable gate arrays or combinations of these (not shown) adapted to execute instructions. The host computer 910 further comprises software 911, which is stored in or accessible by the host computer 910 and executable by the processing circuitry 912. The software 911 includes a host application 912. The host application 912 may be operable to provide a service to a remote user, such as UE 930 connecting via an OTT connection 950 terminating at the UE 930 and the host computer 910. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 910 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with the UE 930 located in a coverage area (not shown in FIG. 12) served by the base station 920. The communication interface 926 may be configured to facilitate a connection 960 to the host computer 910. The connection 960 may be direct or it may pass through a core network (not shown in FIG. 12) of the telecommunication system and/or through one or more intermediate networks outside the telecommunication system. In the embodiment shown, the hardware 925 of the base station 920 further includes a processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes a processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 910. In the host computer 910, an executing host application 912 may communicate with the executing client application 932 via the OTT connection 950 terminating at the UE 930 and the host computer 910. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 910, the base station 920 and the UE 930 illustrated in FIG. 12 may be similar or identical to the host computer 830, one of base stations 812a, 812b, 812c and one of UEs 891, 892 of FIG. 11, respectively. This is to say, the inner workings of these entities may be as shown in FIG. 12 and independently, the surrounding network topology may be that of FIG. 11.

In FIG. 12, the OTT connection 950 has been drawn abstractly to illustrate the communication between the host computer 910 and the UE 930 via the base station 920, without explicit reference to any intermediary devices and the precise routing of messages via these devices. Network infrastructure may determine the routing, which it may be configured to hide from the UE 930 or from the service provider operating the host computer 910, or both. While the OTT connection 950 is active, the network infrastructure may further take decisions by which it dynamically changes the routing (e.g., on the basis of load balancing consideration or reconfiguration of the network).

Wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 950 between the host computer 910 and the UE 930, in response to variations in the measurement results. The measurement procedure and/or the network functionality for reconfiguring the OTT connection 950 may be implemented in software 911 and hardware 915 of the host computer 910 or in software 931 and hardware 935 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which the software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer 910's measurements of throughput, propagation times, latency and the like. The measurements may be implemented in that the software 911 and 931 causes messages to be transmitted, in particular empty or ‘dummy’ messages, using the OTT connection 950 while it monitors propagation times, errors etc.

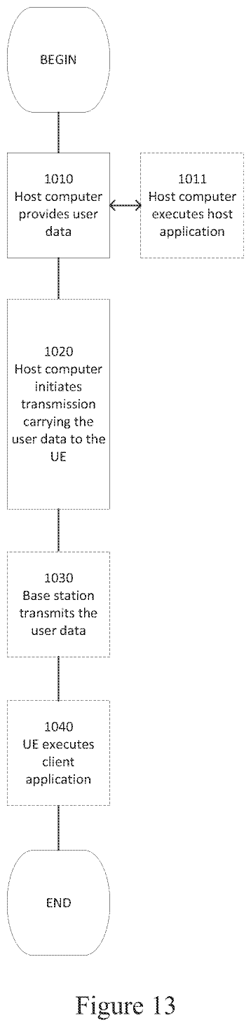

FIG. 13 is a flowchart illustrating a method implemented in a communication system, in accordance with an embodiment. The communication system includes a host computer, a base station and a UE which may be those described with reference to FIG. 11 and FIG. 12. For simplicity of the present disclosure, only drawing references to FIG. 13 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

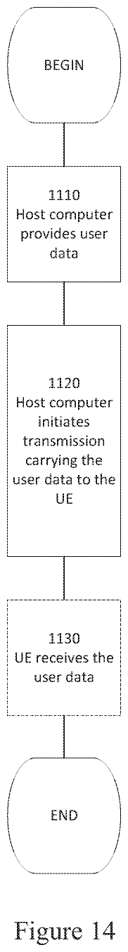

FIG. 14 is a flowchart illustrating a method implemented in a communication system, in accordance with an embodiment. The communication system includes a host computer, a base station and a UE which may be those described with reference to FIG. 11 and FIG. 12. For simplicity of the present disclosure, only drawing references to FIG. 14 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

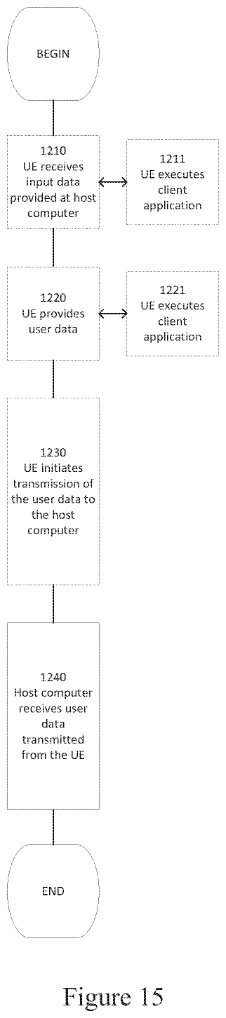

FIG. 15 is a flowchart illustrating a method implemented in a communication system, in accordance with an embodiment. The communication system includes a host computer, a base station and a UE which may be those described with reference to FIG. 11 and FIG. 12. For simplicity of the present disclosure, only drawing references to FIG. 15 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

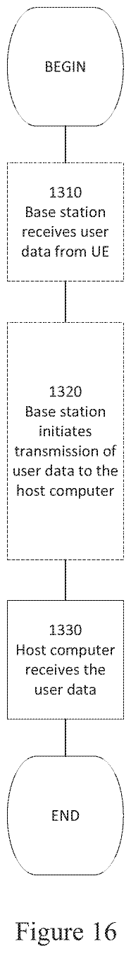

FIG. 16 is a flowchart illustrating a method implemented in a communication system, in accordance with an embodiment. The communication system includes a host computer, a base station and a UE which may be those described with reference to FIG. 11 and FIG. 12. For simplicity of the present disclosure, only drawing references to FIG. 16 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-74. (canceled)

75. A method for configured grant (CG) based transmission in a non-radio resource control (RRC) connected state, the method comprising:
determining resource configuration indicative of one or more physical uplink shared channel (PUSCH) resources allocated for the CG based transmission; and
transmitting to a network node data of the CG based transmission from a user equipment in the non-RRC connected state by utilizing the one or more PUSCH resources according to the determined resource configuration.

76. The method of claim 75, further comprising:
receiving from the network node an RRC signaling indicative of the resource configuration.

77. The method of claim 75, wherein the resource configuration is determined from an allocation list of time domain resources for the CG based transmission in the non-RRC connected state.

78. The method of claim 77, further comprising receiving the allocation list in an RRC signaling from the network node, wherein
the allocation list is indicated by at least one of the following parameters in the RRC signaling:
a higher layer parameter indicative of information on configured uplink grant,
a higher layer parameter indicative of information on CG configuration, or
a higher layer parameter indicative of information on PUSCH configuration.

79. The method of claim 75, wherein the resource configuration is determined from a default allocation list of time domain resources which is predetermined for the CG based transmission in the non-RRC connected state.

80. The method of claim 77, further comprising:
selecting an allocation list of time domain resources from multiple allocation lists of time domain resources as the allocation list of time domain resources for the CG based transmission in the non-RRC connected state.

81. The method of claim 80, wherein the selecting is performed according to the following priority from high to low:
an allocation list of time domain resources received in an RRC signaling,
an allocation list of time domain resources received in a system message, and
a default allocation list of time domain resources.

82. The method of claim 79, wherein the default allocation list of time domain resources is a default time domain resource allocation table.

83. The method of claim 75, further comprising:
receiving from the network node an RRC signaling which comprises at least one of the following parameters:
a starting symbol relative to a start of a slot,
a number of symbols allocated for the CG based transmission in a slot,
a PUSCH mapping type, or
a number of PUSCH repetitions.

84. The method of claim 75, wherein according to the determined resource configuration, multiple PUSCH occasions in a CG period are configured for the CG based transmission in the non-RRC connected state.

85. The method of claim 84, wherein
the multiple PUSCH occasions comprise multiple PUSCH occasions in a time domain per CG period, and
i) the multiple PUSCH occasions in the time domain per CG period are configured with at least one of the following parameters: a number of slots containing the one or multiple PUSCH occasions or a number of PUSCH occasions configured to the CG based transmission in a slot,
ii) the multiple PUSCH occasions in the time domain per CG period are configured with a parameter indicating a total number of the multiple PUSCH occasions in the time domain per CG period, or
iii) the multiple PUSCH occasions in the time domain per CG period are configured based on a PUSCH repetition type for the CG based transmission.

86. The method of claim 85, wherein a starting symbol and a length of a first PUSCH occasion of the multiple PUSCH occasions in the time domain per CG period is determined by a high layer parameter indicative of information on allocation of time domain resources and/or an allocation list of time domain resources.

87. The method of claim 85, further comprising receiving from the network node an RRC signaling which comprises a starting symbol and a length of a first PUSCH occasion of the multiple PUSCH occasions in the time domain per CG period, wherein
the multiple PUSCH occasions in the frequency domain per CG period are configured with a gap between different PUSCH occasions multiplexed in the frequency domain.

88. The method of claim 85, wherein
the multiple PUSCH occasions comprise multiple PUSCH occasions in a frequency domain per CG period, and
i) the multiple PUSCH occasions in the frequency domain per CG period are configured with a parameter indicating a total number of the multiple PUSCH occasions in the frequency domain per CG period, and/or
ii) the multiple PUSCH occasions in the frequency domain per CG period are configured with a gap between different PUSCH occasions multiplexed in the frequency domain.

89. The method according claim 75, wherein the one or more PUSCH resources are allocated in a predetermined bandwidth part.

90. The method of claim 75, further comprising:
receiving from the network node an RRC signaling indicative of a bandwidth part configured for the one or more PUSCH resources.

91. The method of claim 75, wherein both PUSCH repetition type A and PUSCH repetition type B are supported for the CG based transmission on the one or more PUSCH resources; or wherein only PUSCH repetition type A is supported for the CG based transmission on the one or more PUSCH resources.

92. The method of claim 75, wherein
the resource configuration comprises one or more synchronization signal and physical broadcast channel block (SSB) indexes to be used for association with the CG based transmission in the non-RRC connected state,
the one or more SSB indexes are indicated by a parameter in an RRC signaling, and
the method further comprises:
receiving from the network node, an RRC signaling which comprises a parameter indicating the one or more SSB indexes; and
determining one or more SSBs associated to the one or more PUSCH resources according to the parameter indicating the one or more SSB indexes.

93. The method of claim 75, wherein
the RRC signaling is an RRC release message,
the non-RRC connected state is an RRC inactive state or an RRC idle state, or
the CG based transmission is a CG-based small data transmission.

94. An apparatus for configured grant (CG) based transmission in a non-radio resource control (RRC) connected state, the apparatus comprising:
one or more processors; and
one or more memories comprising computer program codes,
the one or more memories and the computer program codes configured to, with the one or more processors, cause the apparatus to:
determine resource configuration indicative of one or more physical uplink shared channel (PUSCH) resources allocated for the CG based transmission; and
transmit to a network node, data of the CG based transmission from a user equipment in the non-RRC connected state by utilizing the one or more PUSCH resources according to the determined resource configuration.
